(19) United States
(12) Patent Application Publication
(10) Pub. No.: US 2026/0098525 A1
(43) Pub. Date: Apr. 9, 2026

(54) HYBRID CEMENTING PUMP

(71) Applicant: Halliburton Energy Services, Inc., Houston, TX (US)

(72) Inventors: Kevin Paul Miller, Houston, TX (US); Craig Allen Sneed, Duncan, OK (US); Joe Sanders, Duncan, OK (US); Troy Dale Bachman, Duncan, OK (US)

(21) Appl. No.: 18/907,961

(22) Filed: Oct. 7, 2024

(51) Int. Cl. F04B 17/03; E21B 33/13; F04B 15/00; F04B 17/06; H02J 3/00

(52) U.S. Cl. CPC F04B 17/03; F04B 15/00; F04B 17/06; H02J 3/0012; E21B 33/13

(57) ABSTRACT

A hybrid cementing apparatus includes a mixing tub; a genset; variable frequency drives electrically coupled to the genset; a transfer switch electrically coupled to the variable frequency drives; electric motors electrically coupled to the variable frequency drives; and pumps mechanically coupled to the electric motors. At least one of the pumps is configured to pump cement out of the mixing tub.

### BACKGROUND

Maintaining power to electric wellbore service equipment can pose significant challenges due to the harsh and unpredictable environment. Equipment must withstand exposure to harsh environmental factors such as extreme temperatures, humidity, and dust, which can lead to power supply issues and equipment degradation. Unexpected power failures can lead to long, costly periods of downtime. The system and method of the present disclosure may address one or more of these issues.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic illustration of a hybrid cementing apparatus, according to an embodiment of the present disclosure;

FIG. 2 is a schematic diagram of a hybrid cementing apparatus, according to an embodiment;

FIG. 3 is a schematic diagram of wellbore equipment, according to an embodiment;

FIG. 4 is a schematic diagram of a wellbore environment, according to an embodiment;

FIG. 5 is a schematic diagram of a hybrid cementing apparatus and various possible power sources, according to an embodiment;

FIG. 6 is a flow diagram of a method of operating a cementing apparatus, according to an embodiment;

FIG. 7 is a flow diagram of a method of operating a cementing apparatus, according to another embodiment;

FIG. 8 is a flow diagram of a method of operating a cementing apparatus, according to yet another embodiment; and

FIG. 9 is a flow diagram of a method of operating a cementing apparatus, according to yet another embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The description that follows includes example systems, methods, techniques, and program flows that embody aspects of the disclosure. However, it is understood that this disclosure may be practiced without these specific details. For brevity, well-known steps, protocols, structures, and techniques have not been shown in detail in order not to obfuscate the description. The disclosure should in no way be limited to the illustrative implementations, drawings, and techniques illustrated below, but may be modified within the scope of the appended claims along with their full scope of equivalents.

As used herein the terms “uphole”, “upwell”, “above”, “top”, and the like refer directionally in a wellbore towards the surface, while the terms “downhole”, “downwell”, “below”, “bottom”, and the like refer directionally in a wellbore towards the toe of the wellbore (e.g. the end of the wellbore distally away from the surface), as persons of skill will understand. Orientation terms “upstream” and “downstream” are defined relative to the direction of flow of fluid, for example relative to flow of well fluid in the well. As used herein, orientation terms “upstream,” “downstream,” are defined relative to the direction of flow of well fluid in the well casing. “Upstream” is directed counter to the direction of flow of well fluid, towards the source of well fluid (e.g., towards perforations in well casing through which hydrocarbons flow out of a subterranean formation and into the casing). “Downstream” is directed in the direction of flow of well fluid, away from the source of well fluid.

The hybrid cementing apparatus according to the present disclosure may obtain electric power from an external genset, a utility, a microgrid, a drilling rig on the well location, or another suitable source of power. An additional genset can also be delivered to the location for providing power to the hybrid cementing apparatus. Given the remote nature of oil and gas wells, as well as maximum output of other machinery that is powered by the electricity source, there may not always be enough excess power capacity to operate the cementing apparatus. In such cases, an on-board genset can be used to power the cementing apparatus. This genset can provide redundancy in the event of a blackout or external generator failure.

The hybrid cementing apparatus of the present disclosure may have power generation that is agnostic to the remote location electric infrastructure. The hybrid cementing unit can be powered by any compatible electric source as well by the genset (e.g., an onboard diesel generator). The hybrid cementing apparatus can run on diesel power or electric power depending on the need or situation. The onboard integrated hybrid genset can also provide redundant power in the case of blackouts or primary electric source failure. Through a transfer switch, the apparatus can continue to receive adequate voltage to perform the cementing job. Conversely, if the diesel genset is being used as a primary power source, redundancy then comes from the connected electric source. Integration of the hybrid genset within the same unit (e.g., trailer) as the cement pump can reduce the number of assets needed for a job. The system and method of the present disclosure may provide flexibility in electric cementing applications while grid infrastructure matures. The onboard transfer switches may swap power sources like a whole home generator.

The VFDs and electric components may be liquid cooled, which may eliminate the need for a separate VFD truck or trailer. This may enable the cementing apparatus of the present disclosure to cement a wide variety of wells.

The cementing apparatus may comprise a cementing truck or trailer. It may comprise an integrated diesel genset, a liquid cooled VFD, a transfer switch, and electric motors configured to drive high pressure pumps. The apparatus may be dispatched to any onshore oil or gas location to pump a cement job. The apparatus can be powered by any adequate electric sources that are already on that location, or it can be powered by the onboard diesel generator. The apparatus can be powered agnostic of the electric power source that it is connected to. In a pre-job rig up, the apparatus may be connected to an alternate adequate power source through high voltage electric lines. The unit can be run as a diesel powered genset only, or additional sources can also be connected for redundancy. Because of the onboard transfer switch, the apparatus can also switch power sources in the event of any blackout or power constraints from the electric sources. The apparatus may automatically switch power sources to the onboard diesel genset as a backup source. Alternatively, if the job required the cement to be pumped with the diesel genset as primary power, the connected secondary electric source would become the redundancy in the event of diesel engine problems that might occur. This method may allow for built-in redundancy with automatic power transfer in electric cementing operations.

In some embodiments, a secondary genset (e.g., not integrated into the single unit) may be brought to location with the apparatus and be tied into the onboard transfer switch. The secondary genset may be a standalone diesel generator, a second hybrid electric cement pump (e.g., similar or identical in structure to the apparatus), or any other suitable configuration. Automatic power source redundancy may be attained even if not contained in a single unit. There may be battery storage implemented as a secondary asset to store energy in the event of blackouts.

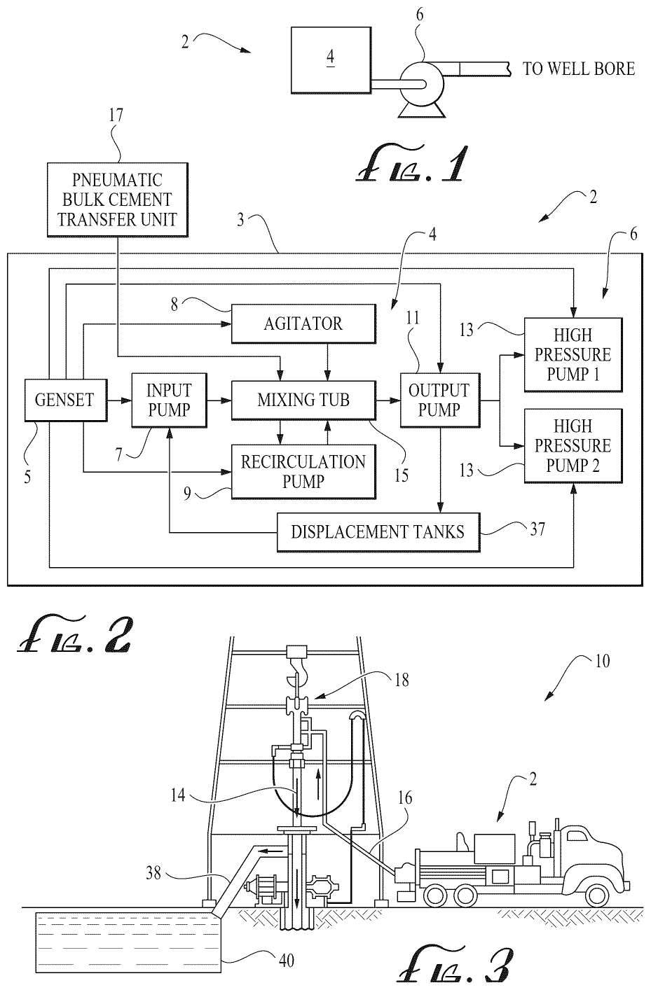

Referring to FIG. 1, an exemplary hybrid cementing apparatus 2 is shown. The hybrid cementing apparatus 2 may include mixing equipment 4 in which a cement composition may be mixed. The mixing equipment 4 may include, for example, a jet mixer, re-circulating mixer, or a batch mixer. The hybrid cementing apparatus 2 may further include pumping equipment 6. The mixture may pumped via pumping equipment 6 to the wellbore. The mixing equipment 4 and the pumping equipment 6 may be disposed on a truck or a trailer. In some embodiments, a jet mixer may be used, for example, to continuously mix the lime/settable material with the water as it is being pumped to the wellbore. In set-delayed embodiments, a re-circulating mixer and/or a batch mixer may be used to mix the set-delayed cement composition, and a passivated cement accelerator may be added to the mixer as a liquid or a powder prior to pumping the cement composition downhole. The passivated cement accelerator may comprise an activator. Alternatively, the activator may be added to the re-circulating mixer and/or a batch mixer before, after, or concurrently with the passivated cement accelerator.

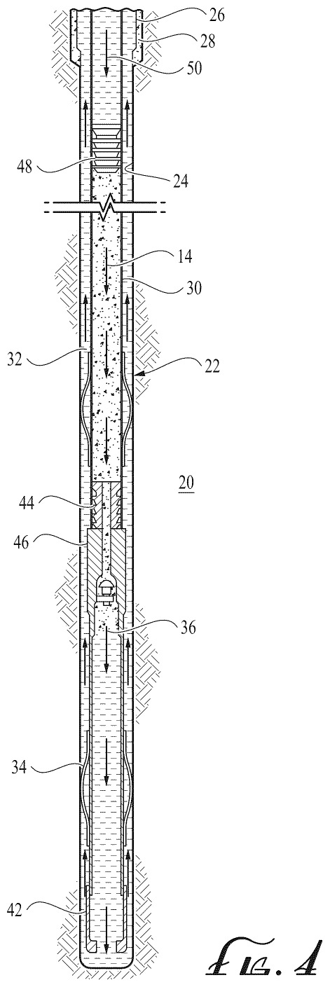

Referring to FIG. 2, the mixing equipment 4 and the pumping equipment 6 may be disposed on a trailer 3. A genset 5 may also be disposed on the trailer 3. The genset 5 may provide power to an input pump 7, an agitator 8, a recirculating pump 9, an output pump 11, and/or high-pressure pumps 13. The input pump 7 may pump fluid (e.g., water) into a mixing tub 15. In the mixing tub 15, the fluid may be mixed with bulk cement from a pneumatic bulk cement transfer unit 17. The agitator 8 may blend the contents of the mixing tub 15. The recirculation pump 9 may recirculate the contents of the mixing tub 15 to maintain consistency. The output pump 11 may pump the blended cement out of the mixing tub 15. The high-pressure pumps 13 may then pump the cement down the wellbore. The hybrid cementing apparatus 2 may also include one or more displacement tanks 37, which may hold water, drilling mud, or brines that can be used to displace the job. The displacement tanks 37 may loop into the input and output pumps.

Referring to FIG. 3, surface equipment 10 is provided. The surface equipment 10 may include the hybrid cementing apparatus 2. The hybrid cementing apparatus 2 may pump a cement composition 14 through a feed pipe 16 and to a cementing head 18, which may convey the cement composition 14 downhole.

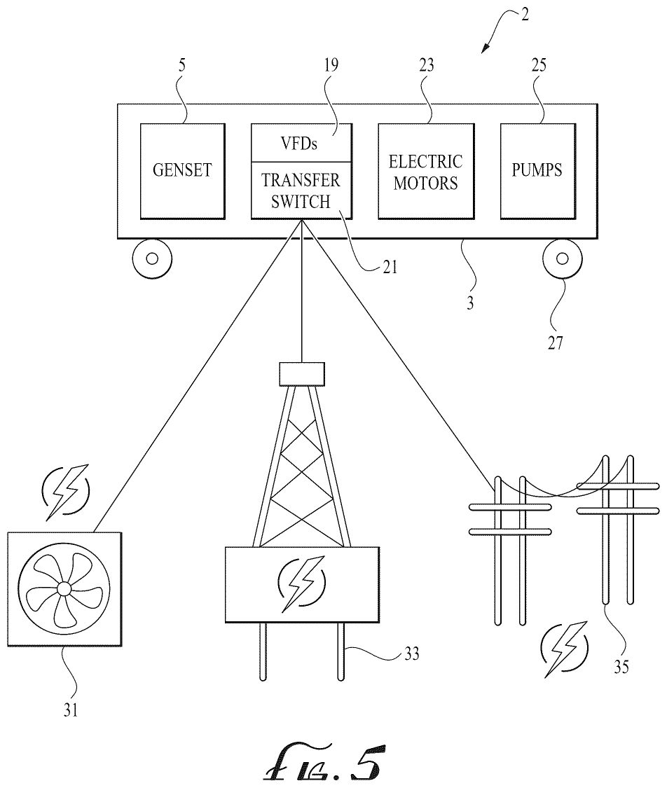

Referring to FIG. 4, the cement composition 14 may be placed into a subterranean formation 20. A wellbore 22 may be drilled into the subterranean formation 20. While wellbore 22 is shown extending generally vertically into the subterranean formation 20, the principles described herein are also applicable to wellbores that extend at an angle through the subterranean formation 20, such as horizontal and slanted wellbores. A surface casing 26 may be inserted into the wellbore 22. The surface casing 26 may be cemented to the walls 24 of the wellbore 22 by cement sheath 28. A casing 30 may also be disposed in the wellbore 22. A wellbore annulus 32 may be formed between the casing 30 and the walls 24 of the wellbore 22 and/or the surface casing 26. One or more centralizers 34 may be attached to the casing 30, for example, to centralize the casing 30 in the wellbore 22 prior to and/or during the cementing operation.

The cement composition 14 may be pumped down the interior of the casing 30. The cement composition 14 may be allowed to flow down the interior of the casing 30 through the casing shoe 42 at the bottom of the casing 30 and up around the casing 30 into the wellbore annulus 32. The cement composition 14 may be allowed to set in the wellbore annulus 32, for example, to form a cement sheath that supports and positions the casing 30 in the wellbore 22. Other techniques, for example, reverse circulation techniques, may be used depending on the application.

The cement composition 14 may displace other fluids 36, such as drilling fluids and/or spacer fluids that may be present in the interior of the casing 30 and/or the wellbore annulus 32. At least a portion of the displaced fluids 36 may exit the wellbore annulus 32 via a flow line 38 and be deposited, for example, in one or more retention pits 40 (e.g., a mud pit), as shown on FIG. 3. Referring to FIG. 4, a bottom plug 44 may be introduced into the wellbore 22 ahead of the cement composition 14, for example, to separate the cement composition 14 from the fluids 36 that may be inside the casing 30 prior to cementing. After the bottom plug 44 reaches the landing collar 46, a diaphragm or other suitable device may rupture to allow the cement composition 14 through the bottom plug 44. The bottom plug 44 may be disposed on the landing collar 46. A top plug 48 may be introduced into the wellbore 22 behind the cement composition 14. The top plug 48 may separate the cement composition 14 from a displacement fluid 50 and also push the cement composition 14 through the bottom plug 44.

Referring to FIGS. 2 and 5, an exemplary hybrid cementing apparatus 2 may include a mixing tub 15; a genset 5; variable frequency drives 19 electrically coupled to the genset 5; a transfer switch 21 electrically coupled to the variable frequency drives 19; electric motors 23 electrically coupled to the variable frequency drives 19; and pumps 25 mechanically coupled to the electric motors 23. At least one of the pumps 25 (e.g., the output pump 11) may be configured to pump cement out of the mixing tub 15. The displacement tanks 37, which may loop into the input pump 7 and the output pump 11, may hold water, drilling mud, or brines used to displace the job with.

The genset 5 may include a diesel-powered electric generator. The mixing tub 15, the genset 5, the variable frequency drives 19, the transfer switch 21, the pumps 25, and the electric motors 23 may be disposed on a trailer 3. The transfer switch 21 may be electrically coupled to a turbine generator 31 (e.g., a diesel or natural gas turbine generator). In some embodiments, multiple turbine generators provide power to the apparatus 2. The transfer switch 21 may be electrically coupled to a drilling rig power source 33. The drilling rig power source 33 may be any source of power used to power a drilling rig (e.g., diesel engines, electric power, hybrid, etc.). Drilling rig generators may be on the ground next to the drilling rig. The rigs may have engines powering rig gensets (e.g., engine/genset package). They may have their own VFDs and it may power each individual component on the rig. A configuration change to the rig power may require a modification to the rig VFD to enable connection. The conserve power to allow the power consumption needs of the apparatus 2 to be met, the drilling rig may be temporarily powered down (e.g., stop any activity consuming power to enable excess power to satisfy the hybrid pump needs (e.g., primarily drilling ahead on another adjacent well)) until the apparatus 2 has completed the cementing operation. The transfer switch 21 may be electrically coupled to a power grid 35 (e.g., a microgrid or a municipal power grid (e.g., comprising a power plant and/or a highline)). The transfer switch 21 may be electrically coupled to the highline. The power grid may also provide power to other wellbore servicing equipment.

The transfer switch 21 may be electrically coupled to another genset. The other genset may be diesel powered. The other genset may be external to the hybrid cementing apparatus. The other genset may be part of another hybrid cementing apparatus. For example, two identical hybrid cementing apparatuses 2 may be connected such that a genset of one of the hybrid cementing apparatuses provides electric power to variable frequency drives of the other.

The variable frequency drives 19 may be liquid cooled. The transfer switch 21 may be configured to switch a power source of the variable frequency drives 19 from an external electric power source to the genset 5, in response to a failure of the external electric power source to supply electric power to the variable frequency drives. That is, in response to detecting that power being supplied to the variable frequency drives 19 by the external electric power source is insufficient, the transfer switch 21 may break the circuit to the external power source and draw power from the genset 5 so that the variable frequency drives 19 can continue to receive sufficient power to operate the motors 23. The transfer switch 21 may be configured to switch a power source of the variable frequency drives from the genset 5 to an external power source, in response to a failure of the genset 5 to supply electric power to the variable frequency drives. That is, in response to detecting that power being supplied to the variable frequency drives 19 by the genset 5 is insufficient, the transfer switch 21 may break the circuit to the genset 5 and draw power from the external power source so that the variable frequency drives 19 can continue to receive sufficient power to operate the motors 23. In either scenario, the transfer switch 21 may be configured to be automatically triggered in response to detecting that the quality of power supplied to the variable frequency drives falls below a threshold. For example, the transfer switch 21 may detect voltage and frequency, which may be used to calculate the power quality. Power quality may be continuously monitored. If it is detected that the power quality falls below an acceptable quality for the variable frequency drives 19 to properly operate, the transfer switch 21 may interrupt the connection to one power source and connect to another power source. The transfer switch 21 may be configured to be automatically triggered in response to detecting that the voltage has gone outside of an acceptable range (e.g., even if the power quality has not dropped below the threshold). For example, if it is detected that the voltage rises above an upper limit or falls below a lower limit, the transfer switch 21 may interrupt the connection to one power source and connect to another power source. The transfer switch 21 may be further configured to be automatically triggered in response to detecting that the frequency has gone outside of an acceptable range (e.g., even if the power quality has not dropped below the threshold). For example, if it is detected that the frequency rises above an upper limit or falls below a lower limit, the transfer switch 21 may interrupt the connection to one power source and connect to another power source. Any of these operations or related operations disclosed herein may be performed by a controller or by a processor. In some embodiments, the genset 5 has sufficient capacity to power the entire hybrid cementing apparatus 2 and/or may by default power the entire hybrid cementing apparatus 2.

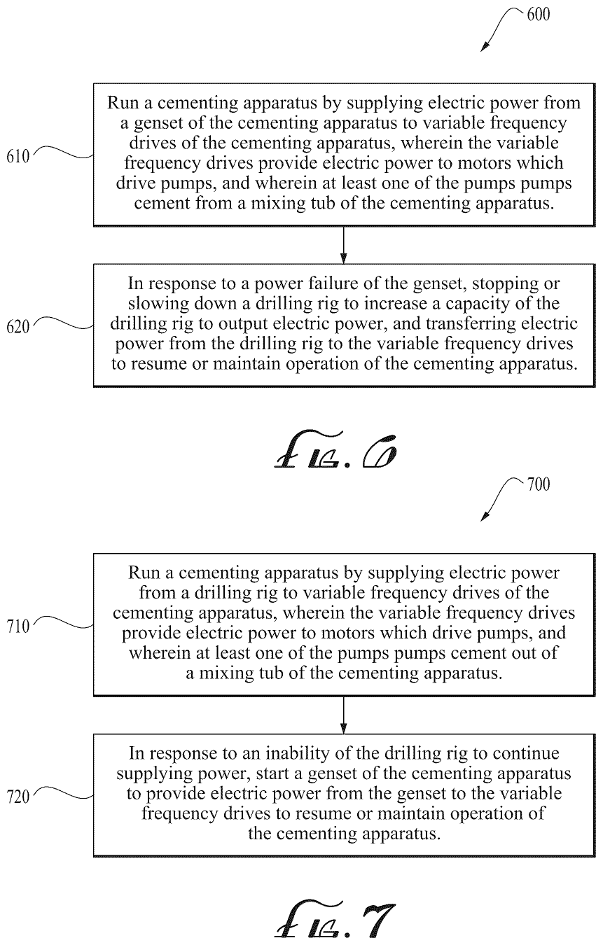

Referring to FIG. 6, a method 600 of operating a cementing apparatus may include the step 610 of running a cementing apparatus by supplying electric power from a genset of the cementing apparatus to variable frequency drives of the cementing apparatus, wherein the variable frequency drives provide electric power to motors which drive pumps, and wherein at least one of the pumps pumps cement out of a mixing tub of the cementing apparatus. The method 600 may further include the step 620 of, in response to a power failure of the genset, stopping or slowing down a drilling rig to increase a capacity of the drilling rig to output electric power, and transferring electric power from the drilling rig to the variable frequency drives to resume or maintain operation of the cementing apparatus. This may include using the transfer switch 21 to interrupt power from the genset to the variable frequency drives, in response to detecting the power failure, and using the transfer switch 21 to connect the power source of the drilling rig to the variable frequency drives. The power failure may be detected based on a power quality falling below a threshold and/or voltage or frequency falling outside of an acceptable range. The increase in the capacity of the drilling rig may enable the drilling rig to fulfill a power requirement of the cementing apparatus (e.g., without the increase in capacity, fulfilling the power requirement may not be possible). The cementing apparatus may be present at the wellsite at the same time as the drilling rig, thus making this transfer possible. Other equipment (e.g., hydraulic fracking pumps) that are not ordinarily at the wellsite at the same time as the drilling rig would not be able to receive power from the drilling unit in the same way. Later, if a power failure of the drilling rig is detected or the drilling rig is otherwise not able to supply the apparatus with sufficient power for its operation, the transfer switch may be used to interrupt the connection of the variable frequency drives to the drilling rig and connect the variable frequency drives to the genset.

Referring to FIG. 7, a method 700 of operating a cementing apparatus may include the step 710 of running a cementing apparatus by supplying electric power from a drilling rig to variable frequency drives of the cementing apparatus, wherein the variable frequency drives provide electric power to motors which drive pumps, and wherein at least one of the pumps pumps cement out of a mixing tub of the cementing apparatus. The method 700 may further include the step 720 of in response to an inability of the drilling rig to continue supplying power, start a genset of the cementing apparatus to provide electric power from the genset to the variable frequency drives to resume or maintain operation of the cementing apparatus. Unlike a hydraulic pump, the cementing apparatus may ordinarily be at the wellsite at the same time as the drilling rig and thus be in the position to receive power therefrom. The inability of the drilling rig to continue supplying power may be detected based on a power quality falling below a threshold and/or voltage or frequency falling outside of an acceptable range. The transfer switch may interrupt power from the drilling rig to the variable frequency drives, in response to detecting the inability of the drilling rig to continue supplying power (e.g., because of a power failure). The transfer switch may connect the genset to the variable frequency drives. Later, if a power failure of the genset is detected, the power transfer switch may be used to interrupt the connection of the variable frequency drives to the genset and connect the variable frequency drives to the drilling rig power source.

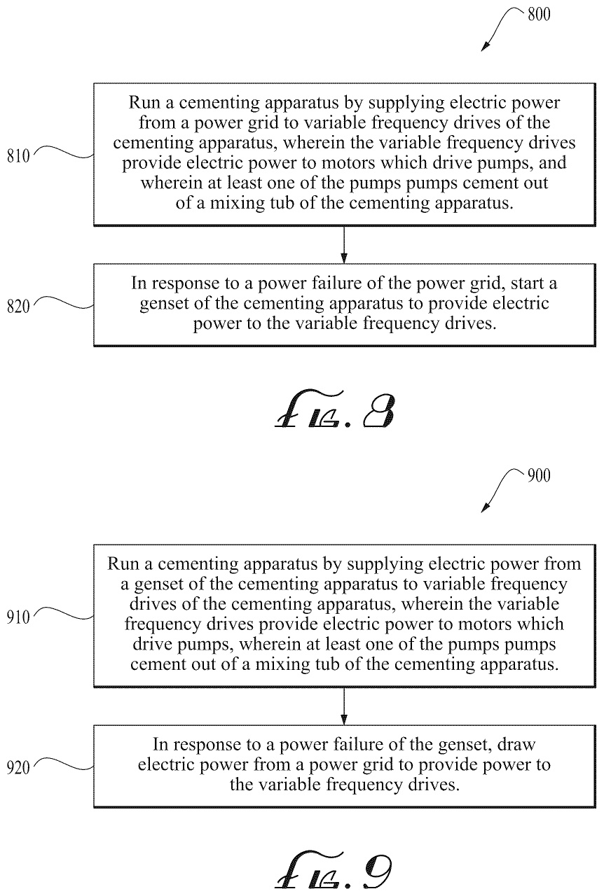

Referring to FIG. 8, a method 800 of operating a cementing apparatus may include the step 810 of running a cementing apparatus by supplying electric power from a power grid (e.g., via a highline) to variable frequency drives of the cementing apparatus, wherein the variable frequency drives provide electric power to motors which drive pumps, and wherein at least one of the pumps pumps cement out of a mixing tub of the cementing apparatus. The method 800 may further include the step 820 of, in response to a power failure of the power grid, starting a genset of the cementing apparatus to provide electric power to the variable frequency drives. In some embodiments, starting the genset prevents a shutdown of the cementing apparatus by helping to maintain a continuous flow of power to the variable frequency drives.

Referring to FIG. 9, a method 900 of operating a cementing apparatus may include the step 910 of running a cementing apparatus by supplying electric power from a genset of the cementing apparatus to variable frequency drives of the cementing apparatus, wherein the variable frequency drives provide electric power to motors which drive pumps, wherein at least one of the pumps pumps cement out of a mixing tub of the cementing apparatus. The method 900 may further include the step 920 of, in response to a power failure of the genset, drawing electric power from a power grid (e.g., via a highline) to provide power to the variable frequency drives. In some embodiments, drawing power from the power grid prevents a shutdown of the cementing apparatus by helping to maintain a continuous flow of power to the variable frequency drives.

The method of the present disclosure may advantageously provide the ability to cement wells with a hybrid electric powered cementing unit as diesel genset power only (e.g., no other connected power sources). It may provide the ability to set any integrated or connected power source as primary power, and any integrated or connected power source as backup power. The method may provide the ability to automatically switch between pre-rigged up power sources through the automatic transfer switch based on voltage requirements. The method may provide the ability to connect multiple hybrid electric cementing pumps together to operate on the same electric power source system. This may enable multiple pumps to provide redundancy for one another on larger cement jobs. The automatic electric power source transfer switch may apply when multiple hybrid electric pumps are connected as a singular common system (e.g., with or without additional supplementary power sources).

### ADDITIONAL DISCLOSURE

The following are non-limiting, specific embodiments in accordance with the present disclosure:
In a first embodiment, a hybrid cementing apparatus comprises a mixing tub; a genset; variable frequency drives electrically coupled to the genset; a transfer switch electrically coupled to the variable frequency drives; electric motors electrically coupled to the variable frequency drives; and pumps mechanically coupled to the electric motors, wherein at least one of the pumps is configured to pump cement from the mixing tub.

A second embodiment can include the hybrid cementing apparatus of the first embodiment, wherein the genset comprises a diesel-powered electric generator.

A third embodiment can include the hybrid cementing apparatus of the first or second embodiments, wherein the mixing tub, the genset, the variable frequency drives, the transfer switch, the pumps, and the electric motors are disposed on a trailer.

A fourth embodiment can include the hybrid cementing apparatus of any of the first through third embodiments, wherein the transfer switch is configured to be electrically coupled to a natural gas turbine generator.

A fifth embodiment can include the hybrid cementing apparatus of any of the first through fourth embodiments, wherein the transfer switch is configured to be electrically coupled to a drilling rig power source.

A sixth embodiment can include the hybrid cementing apparatus of any of the first through fifth embodiments, wherein the transfer switch is configured to be electrically coupled to a municipal power grid or a microgrid.

A seventh embodiment can include the hybrid cementing apparatus of any of the first through sixth embodiments, wherein the transfer switch is configured to be electrically coupled to another genset.

An eighth embodiment can include the hybrid cementing apparatus of any of the first through seventh embodiments, wherein the other genset is diesel powered.

A ninth embodiment can include the hybrid cementing apparatus of any of the first through eighth embodiments, wherein the other genset is external to the hybrid cementing apparatus.

A tenth embodiment can include the hybrid cementing apparatus of any of the first through ninth embodiments, wherein the other genset is part of another hybrid cementing apparatus.

An eleventh embodiment can include the hybrid cementing apparatus of any of the first through tenth embodiments, wherein the variable frequency drives are liquid cooled.

A twelfth embodiment can include the hybrid cementing apparatus of any of the first through eleventh embodiments, wherein the transfer switch is configured to switch a power source of the variable frequency drives from an external electric power source to the genset, in response to a failure of the external electric power source to supply electric power to the variable frequency drives.

A thirteenth embodiment can include the hybrid cementing apparatus of any of the first through twelfth embodiments, wherein the transfer switch is configured to switch a power source of the variable frequency drives from the genset to an external power source, in response to a failure of genset to supply electric power to the variable frequency drives.

A fourteenth embodiment can include the hybrid cementing apparatus of any of the first through thirteenth embodiments, wherein the transfer switch is configured to be automatically triggered in response to detecting that quality of power supplied to the variable frequency drives falls below a threshold.

A fourteenth-A embodiment can include the hybrid cementing apparatus of any of the first through fourteenth embodiments, wherein the hybrid cementing apparatus is coupled to a wellhead.

A fourteenth-B embodiment can include the hybrid cementing apparatus of any of the first through fourteenth-A embodiments, wherein the pumps are further configured to pump the cement into an annular space between a tubular and a wellbore wall.

In a fifteenth embodiment, a method of operating a cementing apparatus comprises running a cementing apparatus by supplying electric power from a genset of the cementing apparatus to variable frequency drives of the cementing apparatus, wherein the variable frequency drives provide electric power to motors which drive pumps, and wherein at least one of the pumps pumps cement from a mixing tub of the cementing apparatus; and in response to a power failure of the genset, stopping or slowing down a drilling rig to increase a capacity of the drilling rig to output electric power, and transferring electric power from the drilling rig to the variable frequency drives to resume or maintain operation of the cementing apparatus.

A sixteenth embodiment can include the method of the fifteenth embodiment, wherein the genset comprises a diesel-powered electric generator.

A seventeenth embodiment can include the method of the fifteenth or sixteenth embodiments, wherein the mixing tub, the genset, the variable frequency drives, a transfer switch electrically coupled to the variable frequency drives, the pumps, and the electric motors are disposed on a common trailer.

A seventeenth-A embodiment can include the method of any of the fifteenth through seventeenth embodiments, wherein the cementing apparatus is coupled to a wellhead.

A seventeenth-B embodiment can include the method of any of the fifteenth through seventeenth-A embodiments, wherein the at least one of the pumps pumps cement into an annular space between a tubular and a wellbore wall.

In an eighteenth embodiment, a method of operating a cementing apparatus comprises running a cementing apparatus by supplying electric power from a drilling rig to variable frequency drives of the cementing apparatus, wherein the variable frequency drives provide electric power to motors which drive pumps, and wherein at least one of the pumps pumps cement from a mixing tub of the cementing apparatus; and in response to an inability of the drilling rig to continue supplying power, starting a genset of the cementing apparatus to provide electric power from the genset to the variable frequency drives to resume or maintain operation of the cementing apparatus.

A nineteenth embodiment can include the method of the eighteenth embodiment, wherein the genset comprises a diesel-powered electric generator.

A twentieth embodiment can include the method of the eighteenth or nineteenth embodiments, wherein the mixing tub, the genset, the variable frequency drives, a transfer switch electrically coupled to the variable frequency drives, the pumps, and the electric motors are disposed on a common trailer.

A twenty-first embodiment can include the method of any of the eighteenth through twentieth embodiments, wherein the cementing apparatus is coupled to a wellhead.

A twenty-second embodiment can include the method of any of the eighteenth through twenty-first embodiments, wherein the at least one of the pumps pumps cement into an annular space between a tubular and a wellbore wall.

A twenty-third embodiment can include the subject matter of any of the first through twenty-first embodiments, wherein the cementing apparatus further comprises displacement tanks fluidly coupled to the mixing tub.

A twenty-fourth embodiment can include the subject matter of any of the first through twenty-third embodiments, wherein the pumps comprise centrifugal pumps and reciprocating plunger (e.g., high pressure triplex) pumps.

A twenty-fifth embodiment can include the subject matter of any of the first through twenty-fourth embodiments, wherein cement used in the cementing apparatus comprises non-Portland cement.

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc. ; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k* (Rᵤ-Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Disclosure of a singular element should be understood to provide support for a plurality of the element. It is contemplated that elements of the present disclosure may be duplicated in any suitable quantity.

Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” does not require selection of only one element. Thus, the phrase “A or B” is satisfied by either one or both elements from the set {A, B}, including multiples of either element; and the phrase “A, B, or C” is satisfied by any element from the set {A, B, C} or any combination thereof, including multiples of any element. A clause that recites “A, B, or C” can be infringed with only one of the listed items, multiple of the listed items, and one or more of the items in the list and another item not listed.

As used herein, the article “a” means “one or more.” As used herein, the article “an” means “one or more.” As used herein, the article “the” when referring to a singular noun means “the one or more.” Thus, the phrase “an element” means “one or more elements;” and the phrase “the element” means “the one or more elements.”

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A hybrid cementing apparatus, comprising:
a mixing tub;
a genset;
variable frequency drives electrically coupled to the genset;
a transfer switch electrically coupled to the variable frequency drives;
electric motors electrically coupled to the variable frequency drives; and
pumps mechanically coupled to the electric motors, wherein at least one of the pumps is configured to pump cement from the mixing tub.

2. The hybrid cementing apparatus of claim 1, wherein the genset comprises a diesel powered electric generator.

3. The hybrid cementing apparatus of claim 1, wherein the mixing tub, the genset, the variable frequency drives, the transfer switch, the pumps, and the electric motors are disposed on a trailer.

4. The hybrid cementing apparatus of claim 1, wherein the transfer switch is configured to be electrically coupled to a natural gas turbine generator.

5. The hybrid cementing apparatus of claim 1, wherein the transfer switch is configured to be electrically coupled to a drilling rig power source.

6. The hybrid cementing apparatus of claim 1, wherein the transfer switch is configured to be electrically coupled to a municipal power grid or a microgrid.

7. The hybrid cementing apparatus of claim 1, wherein the transfer switch is configured to be electrically coupled to another genset.

8. The hybrid cementing apparatus of claim 7, wherein the other genset is diesel powered.

9. The hybrid cementing apparatus of claim 7, wherein the other genset is external to the hybrid cementing apparatus.

10. The hybrid cementing apparatus of claim 7, wherein the other genset is part of another hybrid cementing apparatus.

11. The hybrid cementing apparatus of claim 1, wherein the variable frequency drives are liquid cooled.

12. The hybrid cementing apparatus of claim 1, wherein the transfer switch is configured to switch a power source of the variable frequency drives from an external power source to the genset, in response to a failure of the external power source to supply electric power to the variable frequency drives.

13. The hybrid cementing apparatus of claim 1, wherein the transfer switch is configured to switch a power source of the variable frequency drives from the genset to an external power source, in response to a failure of the genset to supply electric power to the variable frequency drives.

14. The hybrid cementing apparatus of claim 1, wherein the transfer switch is configured to be automatically triggered in response to detecting that quality of power supplied to the variable frequency drives falls below a threshold.

15. A method of operating a cementing apparatus, comprising:
running a cementing apparatus by supplying electric power from a genset of the cementing apparatus to variable frequency drives of the cementing apparatus, wherein the variable frequency drives provide electric power to motors which drive pumps, and wherein at least one of the pumps pumps cement from a mixing tub of the cementing apparatus; and
in response to a power failure of the genset, stopping or slowing down a drilling rig to increase a capacity of the drilling rig to output electric power, and transferring electric power from the drilling rig to the variable frequency drives to resume or maintain operation of the cementing apparatus.

16. The method of claim 15, wherein the genset comprises a diesel powered electric generator.

17. The method of claim 15, wherein the mixing tub, the genset, the variable frequency drives, a transfer switch electrically coupled to the variable frequency drives, the pumps, and the electric motors are disposed on a common trailer.

18. A method of operating a cementing apparatus, comprising:
running a cementing apparatus by supplying electric power from a drilling rig to variable frequency drives of the cementing apparatus, wherein the variable frequency drives provide electric power to motors which drive pumps, and wherein at least one of the pumps pumps cement from a mixing tub of the cementing apparatus; and
in response to an inability of the drilling rig to continue supplying power, starting a genset of the cementing apparatus to provide electric power from the genset to the variable frequency drives to resume or maintain operation of the cementing apparatus.

19. The method of claim 18, wherein the genset comprises a diesel powered electric generator.

20. The method of claim 18, wherein the mixing tub, the genset, the variable frequency drives, a transfer switch electrically coupled to the variable frequency drives, the pumps, and the electric motors are disposed on a common trailer.
